(19) United States
(12) Patent Application Publication
(10) Pub. No.: US 2002/0187750 A1
(43) Pub. Date: Dec. 12, 2002

(54) Method and apparatus for service management, delegation and personalization

(76) Inventor: Kalyan Sankar Majumdar, Alamo, CA (US)

Correspondence Address: Kalyan Majumdar, 1449 Twelve Oaks Ct., Alamo, CA, 94507, US

(21) Appl. No.: 10/167,798

(22) Filed: Jun. 11, 2002

Related U.S. Application Data
(60) Provisional application No. 60/297,844, filed on Jun. 12, 2001.

(51) Int. Cl. H04B 1/38

(52) U.S. Cl. 455/41; 455/550; 455/517

(57) ABSTRACT

The invention is a computing system that intermediates between an individual and an array of external services and resources and enables computing devices to be selectively delegated responsibility for managing these services based upon owners' interests and preferences. Rules are applied to determine which service offerings on the web or from nearby communications enabled devices are of interest and service access is initiated based upon the recipient's prevailing needs and priorities. The software filters unsolicited messages and advertisements and responds to requests of interest from service providers. It also coordinates transactions with multiple service providers as well as local resources on the device to facilitate electronic commerce transactions and deliver value added services. This software paradigm allows computing devices greater latitude in taking decisions within specified ground rules and user preferences. This invention can be used in mobile wireless computing devices as well as on desktop, technical, professional and enterprise computing environments.

### CROSS-REFERENCE TO RELATED APPLICATIONS

This application claims the benefit of U.S. provisional application Ser. No. 60/297,844, filed Jun. 12, 2001, entitled “Method and apparatus for service management, delegation and personalization”.

### FIELD OF THE INVENTION

This invention relates to the field of computing software and, more particularly, to computing apparatus operable across multiple platforms, including mobile wireless computing devices.

### BACKGROUND OF THE INVENTION

With the growth of mobile computing and wireless data networks, the mobile device owner will encounter an increasing array of service offerings and resources as he transitions through and spends time in different environments. Some services will be predictable and expected, some unsolicited but welcome means to fulfill pending needs, some will present serendipitous opportunities to pursue the owner's interests, while others will be unwelcome or unnecessary. These will proliferate with the expansion of mobile computing and tend to overwhelm the owner unless more sophisticated software is developed to mediate interaction with services and reduce human intervention.

Unlike today's personal software, which generally requires interaction with the means rather than allowing users to specify the desired end, it will no longer be feasible to manually interact with each service offering, determine whether it is of interest, access one that is and reject others, select a menu option, choose preferred settings and initiate service access without inordinate commitment of time and unacceptable interruptions.

A different computing paradigm that supports a more ‘human’ pattern of behavior will become necessary, whereby the owner can express his changing needs, preferences, priorities and interests, define a set of rules and allow the computing device to act as his surrogate while interacting with external service offerings within the purview of varying delegations of responsibility.

Approaches to discovering and identifying services offered by different service providers exist in prior art. For example, the Service Discovery Protocol in Bluetooth provides a framework to discover and identify services. Web Services is an effort under the auspices of The World Wide Web Consortium (W3C) to develop standards for service offerings to be comprehensible among unknown entities. Mechanisms for defining rules also exist in prior art, for example U.S. Pat. No. 5,809,492, “Apparatus and method for defining rules for personal agents”.

These provide solutions to only a subset of problems and capabilities addressed by this invention, the scope of which is described in the sections that follow.

### SUMMARY OF THE INVENTION

This invention represents personal, individual-centric software that facilitates the owner's interaction with services in his or her environment. The software allows computing devices to be delegated certain responsibilities and permitted to interact with a dynamic collection of external services and resources based upon clearly specified rules and the owner's evolving needs, priorities, preferences and interests. It makes choices and initiates service access, accepts or rejects offers, filters advertisements and coordinates and orchestrates services between multiple devices or service providers to deliver composite services of higher value. It enables the owner to specify ends and allows mobile devices to deal with the means.

The software works in conjunction with the operating system of a computing device and communications protocols to detect the presence of a service provider device or software application, understand interface details and control methods for interacting with the services it provides, create a collaborative session and negotiate services provided by each device or application and begin accessing services based upon the owner's needs, interests and preferences. It holds state information, acts as middleware and transaction manager and is a repository for personal information and secure payments data. Programmable agents can be created that initiate transactions, generate events, produce alerts, create searches, respond to offers of service and indicate user preferences. A processing engine reviews options, makes choices, takes decisions and initiates transactions and search threads. Interfaces to telephony and other software application programming interfaces extend these benefits to familiar desktop applications and enterprise information systems.

Service properties and attributes determine what class of service a device or software application provides and how the service or resource is accessed. Services can be for personal, professional/technical and business use. A service provider offers a list of services, ranging from simple state information about the device or service, properties and attributes it provides, to more intricate control mechanisms by which to interact with them. A protocol for application services defines categories of services and their properties and attributes, including controls available for each device or service, their operating range (default values, minimum and maximum, etc.) and state.

Objects and Advantages

Several objects and advantages of the invention are:

a) It facilitates growth of mobile computing by augmenting the capabilities of a mobile device and enhancing its utility and value to owners.

b) It provides a means of delegating service interaction and intermediates between services to enable an enhanced level of automation in service access, thus avoiding being overwhelmed by frequent interruptions or foregoing useful opportunities.

c) It allows a mobile device to represent the owner and make decisions and authorizations on behalf of the owner.

d) It acts as a focal point for coordinating transactions between multiple intelligent devices and other service providers that may be unknown to each other.

e) It provides added value by creating composite services from multiple elemental sources.

f) It would allow specialized medical devices and equipment to be easily brought together to cooperate and deliver orchestrated services to a patient, consistent with prescribed treatments.

g) It allows similar cooperation in delivering services among multiple diverse devices, equipment, robotics and computer applications in specialized technical, professional and industrial environments.

### BRIEF DESCRIPTION OF THE DRAWINGS

FIG. 1 describes the operational environment of the invention.

FIG. 2 is a block diagram of the software invention.

### DETAILED DESCRIPTION OF PREFERRED EMBODIMENTS

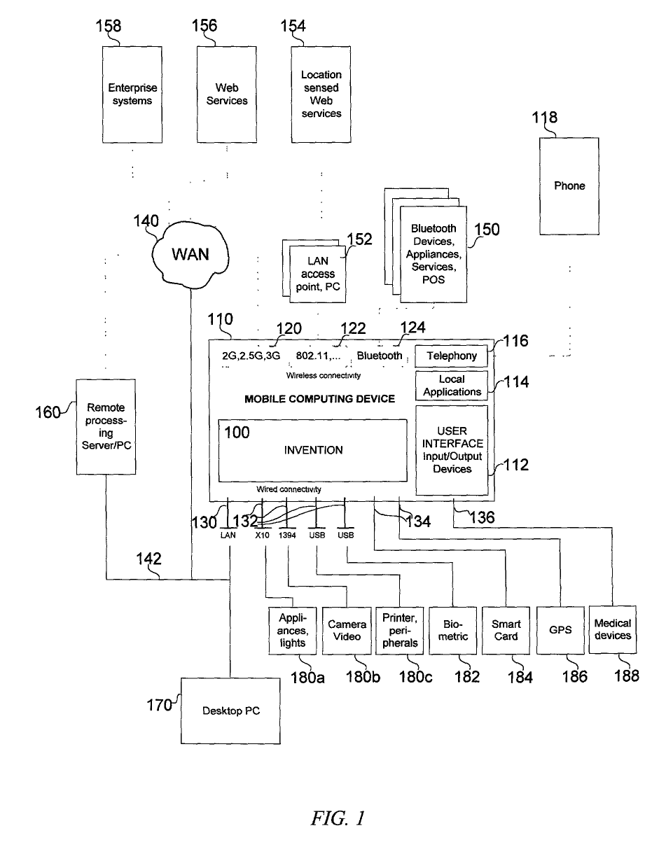

In its preferred embodiment, the invention operates within a wireless communications-capable mobile computing device (110 referring to FIG. 1), preferably incorporating functionality of mobile phones (116, 118), personal digital assistants (PDAs) and portable computers as represented by local applications 114, device remote control functions (150 and 180a), internet services (154 and 156) and personal- (124), local- (122, 130, 142) and wide-area (140) networking capability. Devices incorporating one or more of such functions are established in prior art and their evolution is expected to lead to increasing convergence of these capabilities within one device.

The device has resources such as a user interface (112) represented by display screen, audio input and output, user input mechanisms such as keyboard, a stylus or mouse based pointing device, voice input and various devices that can be either physically incorporated into the device (134) or plugged-in, such as devices for image capture 180b, biometric input 182, GPS location sensing 186, persistent and transient data storage, message queues, communications mechanisms including wireless voice 116 and data communications (120, 122, 124) as well as wired data communications interfaces (130, 132). The mobile computing device runs operating system software, also established in prior art, to provide the basic functionality of the device, which includes coordination of these resources and software applications. The device also runs application software both locally, such as a calendar, phone book, etc. (114) and remotely by accessing public web sites (156), enterprise systems (158) and personal computers (170) using a web browser or customized client software.

The computing device has universal connectivity available from any location within wireless network coverage or with wired network access to locations potentially anywhere in the world through wide area networking. In addition, a variety of devices and appliances are encountered, come within radio frequency proximity and establish ephemeral communications using personal area networking technologies such as Bluetooth (122) as the device transitions through different environments.

Wireless communications interfaces include Bluetooth (122), wireless local area network (LAN) standards such as 802.11 (122) and Home RF and different 2G, 2.5G and 3G mobile network (120) standards such as GPRS, EDGE, CDMA2000, UMTS and the like. Wired communications include familiar LAN technologies (130) such as Ethernet that can be interconnected (142) to wide area networks (140) providing Internet access as well as USB, IEEE 1394, and the like (132) that support a variety of devices for audio, images, video and computer peripherals. The present invention uses the operating system's interfaces to communications protocols in order to interact with service providers and devices.

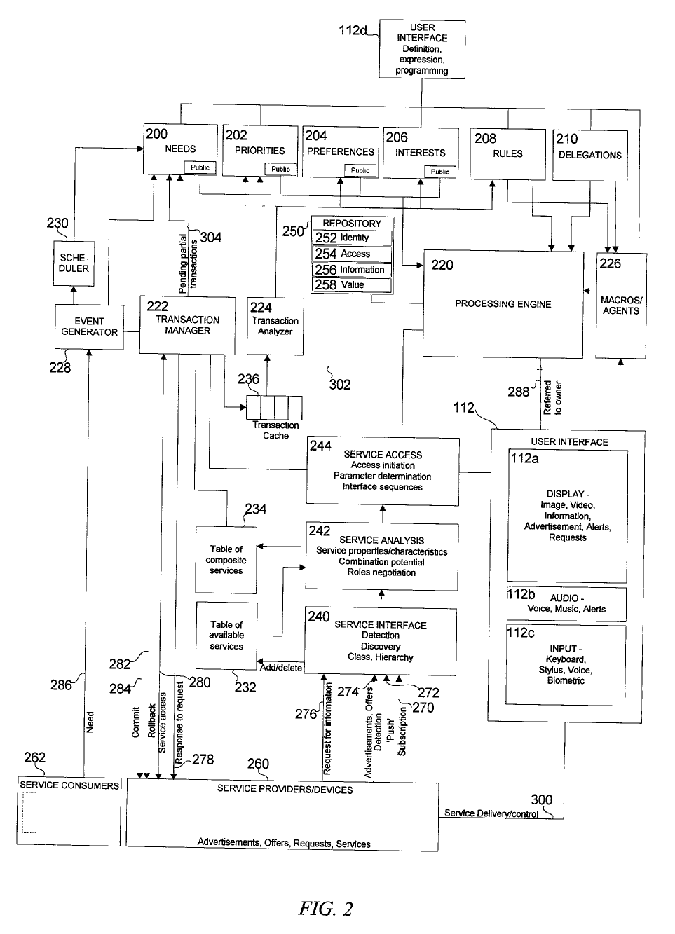

Communications capable intelligent devices can be regarded as providers of different services or as resources of different kind. In many instances, the provider of service is not visible as a physical device or appliance but can be a software application or computer program delivering an intangible service such as searching for a book in an electronic catalog at a library or reporting a bank balance via the Internet. Similar computer programs or applications can also be embedded within electronic components of intelligent physical devices referenced in the present context. All such instances are generically referred to as service providers for the purposes of this invention (represented by 260 in FIG. 2).

Some service providers are proactive and make their presence known to devices within their proximity, such as Bluetooth enabled devices and ‘push’ type of Web applications which may offer services or advertisements specific to a location or the owner's interests and needs. These offer services that may be unsolicited. Others are passive and require communications to be initiated and services requested before they can be accessed.

This invention manages interaction with all such services and intermediates between an individual mobile device owner or consumer of services and all service providers on behalf of the owner. It provides the capability for an individual owner to delegate responsibility for interaction with service providers and devices in varying degrees. The invention allows the owner's personal preferences (204), interests (206), priorities (202) and needs (200) to influence interaction with service providers. Rules of behavior (208) and parameters within which responsibility for action is delegated (210) to the software are defined by the owner. The software inserts itself between the owner and service providers and monitors and intervenes in interaction with services based upon delegated responsibility. In addition, it manages the mechanics and logistics of interaction with service providers. It also interacts with the operating system and other software applications in the process.

The invention is software. This software has a number of design elements that represent capabilities to interact with services, enable definition of interests, needs, preferences, priorities, delegation levels and rules and performs diverse forms of processing.

The software becomes aware of a service in one of several ways. A device or appliance could come within radio frequency range, be detected (274) and queried about the services it provides or a software application may ‘push’ advertisements or service offers (272). The location of the mobile device could be sensed and a subset of services specifically tailored for that location (154) may be offered or advertised. The user could have subscribed to a variety of ‘channels’ or event emitters and be alerted when an event occurs (270). Other services are proactively sought through searches on the Internet or from specialized sources such as enterprise systems (158) or professional/technical service subscriptions and memberships.

When a service is offered or detected, the service interface manager (240) is notified of the offer and begins a dialog to discover more information about the service, such as service class and type of services provided, together with their properties. Once this information is received, a table of currently available services (232) is updated. Service characteristics are analyzed (242) and compared with the owner's needs, interests and preferences to determine whether the service will be accessed. The potential for combining this service with others in order to fulfill a pending need or to complete a complex transaction is also analyzed.

The decision to access a service is made by the processing engine (220). Inputs to the decision include the owner's pending needs and interests as well as characteristics of the service being offered. If access to a service class has been delegated fully or partially, the processing engine initiates service access and performs all interaction consistent with the level of delegated responsibility.

When advertisements are received, the processing engine checks the owner's interests and needs and filters out those that will be of no interest and pass through to the owner others that will. When a request for information (276) is received, it responds to the request based on the type of requestor and specified rules and returns a subset of designated public information regarding interests, preferences, needs and priorities of the owner relevant to the request (278). Similarly, when an offer of service is received, pending needs are reviewed. If a need exists, attributes and characteristics of the service are compared with the owner's needs and interests and if there is a match, a determination is made regarding what services will be accessed and to what extent service access will be automatically initiated based on the level of delegated responsibility for that service as specified by the owner. The processing engine then initiates service access and supplies required parameters based on the owner's preferences, needs and priorities. When its delegated authority is exceeded, information input or authorization is requested from the owner (288) via the user interface (112).

If there is a need, but the service has not been delegated, it is referred to the owner for manual interaction (288). If there is no pending need, the owner's interests are reviewed to determine whether there is a match, and if so, the service is referred to the owner; if not, it is rejected or ignored, as appropriate, consistent with the service interface protocol.

If a determination is made to access the service, values of parameters and attributes to be used are determined based upon the level of delegation of responsibility specified for that service and the owner's preferences. The sequence of transactional steps required to complete the service access transaction are determined by the processing engine based upon preferences and rules specified by the owner and executed by the service access manager (244). Where these have not been specified in sufficient detail, input and intermediate output is referred to the owner. A capability to create programmable macros (226) and agents to handle complex transactional interfaces is provided.

Macros record specific steps in navigating and completing the transaction. Macros may be created by analyzing (302) and editing a manually completed transaction by the owner or by pre-programming the steps through a user interface (112d). In addition to macros, agents may be created which proactively look for services based on user needs, interests and priorities from all accessible resources, such as the Internet, enterprise systems and specialized professional/technical sources.

The software interacts with services using messages. A service consists of attributes and methods by which different functions or transactions may be accessed. Service properties and attributes and the concepts of “needs”, “interests”, “preferences” and “behaviors” are defined in a standard ‘language’ such as extensible markup language (XML) using XML Schema, or the like, so that services will be understood across different service providers, together with interdependencies and associations among multiple services and service classes.

A transaction manager (222) manages access to services (280). For transactions involving a single service provider or device, the transaction manager ensures that a transaction is correctly completed and committed (284), or rolled back (282) if incomplete in the event that a service provider becomes unavailable prior to completion of a transaction—for example when a Bluetooth device is no longer within radio frequency proximity. When multiple service providers are involved, the transaction manager coordinates and orchestrates transactions and maintains a transient table of steps that constitute composite services (234), recording service dependencies between providers, the negotiated role of each service provider in a composite transaction, and service bindings, indicating relationships, inputs and outputs between service providers.

If a service provider becomes unavailable before the completion of a composite transaction, the nature of the composite service, its priority for the owner, and the nature of constituent service providers determine the treatment of steps that are yet to be completed. In some cases, remaining steps can be placed as pending needs (304) by the transaction manager. In other cases, a decision may be made to rollback the partially completed transactions. Before a composite service is initiated, the potential and feasibility for combining the available services to create a composite service are analyzed (242). In some cases a decision may be made to initiate a service and process initial stages of a composite service without all constituent service providers being present and to generate one or more pending transaction to be subsequently completed when relevant service providers become available. In other cases the nature of the composite service may be such that service may not be effectively delivered without all component service providers being available and the requested service may be denied.

Needs can be created manually via the user interface (112d), for example a need to withdraw cash from an automated teller machine. Needs can also be created by authorized devices or applications that are also service consumers (262), for example when the owner's car needs gasoline or a digital camera needs to print a photograph. Needs can also be generated by a scheduler (230) for recurring transactions or future transactions. In addition, the transaction manager can create needs resulting from uncompleted steps of a composite transaction involving multiple service providers or devices. An event generator (228) is responsible for creating all events, including needs. Other events include reminders for the owner on the calendar initiated by authorized service providers, or initiation of a search on the web.

The owner's interests, preferences, needs and priorities as well as delegation of responsibility to the software are contained within a repository. While this is private information primarily for internal use, a public subset of this information may be defined for each. In response to requests from service providers (276) and depending on their type and identity, varying amounts of the public information are provided in order to facilitate service providers in making relevant offers and constructing customized services.

A cache containing recent transactions (236) is maintained in order to provide default values based on decisions and choices made in similar past transactions where these have not been defined. An analyzer reviews past transactions and determines default values of interests and preferences and, to some extent, needs and priorities based upon past behavior. In some cases the transaction manager can also create needs and priorities as an outcome of complex transactions between multiple service providers.

While the software mediates interaction with service providers, negotiates and controls service parameters and may make electronic payment for services, depending on the nature of the service, delivery of services may or may not occur via the mobile device. Many services are delivered by physical devices directly to the owner, such as cash from an automated teller machine or driving directions from a car navigation system. Some services are delivered directly to the mobile device, such as digital music, video or email. In these cases service delivery occurs directly (300) to the user interface of the device and is controlled through the user interface, such as via a volume control to adjust the sound level or a pause button to momentarily stop video playback. In other cases, the user interface of the device can control services that are delivered by other devices. Software applications also provide ‘remote controls’ via the user interface to operate devices such as domestic appliances, home entertainment, security, etc.

The architecture and design of the software will preferably support a distributed processing capability. Certain functionality need not be resident on the device and can run on a remote computer (160), such as a hosted server or a personal computer, accessible from the mobile network. The mobile device provides certain inputs and receives certain outputs from the remote process. For example, communication with service providers in physical proximity of the device, such as via Bluetooth, is performed by the mobile device but data may be sent to and received from the remote process for further interaction with the local service or for display of output or for owner input. The owner will have the ability to select and distribute locally and remotely executed functionality. The limiting case is where all functionality is either local or remote, although there will be tradeoffs in performance, network traffic, etc. as a consequence of the level of distribution chosen. A capability to download selected functionality and execute it locally on the device is also provided. Distribution decisions may be influenced by factors such as limited resources of a class of mobile device, infrequently used functionality or disproportionately resource-intensive processing requirements, etc. An alternate user interface is available on a desktop PC (170) to define delegations, rules, preferences, interests, needs and priorities that can be synchronized with the mobile device.

A desktop PC or remote system will also act as a backup of all data contained on the mobile device from which a new device can be setup or an existing one refreshed in the event of device failure or data corruption. Synchronization mechanisms exist in prior art for data from desktop and other applications, such as calendar and phone book, to be synchronized with those on the mobile device.

The mobile device has access to considerable confidential personal information, including electronic owner identity, personal information profiles, secure access keys and passwords, account information and authorization codes as well as electronic stores of value, such as electronic cash, discount coupons, commuter tickets and tolls, highlighting the need for adequate security. In many cases, these are physically stored in the device (250) and require security mechanisms to protect the device and its contents. In some cases, the information is held in network-accessible remote data stores, with the software having the capability to securely retrieve and supply this information to an authorized service provider entity. In other cases, the service provider is supplied with an unique, single-use digital authorization ‘key’, generated for a specific transaction and valid for a specified service provider for a specified time period, to access this information from the remote data store. Support for a variety of encryption schemes and familiar techniques established in prior art, such as encrypted access to private keys, etc., will be provided.

A combination of design features protect the contents of the mobile device. Some preferred mechanisms include a detached wireless component that accompanies the mobile device, but is typically carried separately. The mobile device is disabled if both components are not in close proximity. Login IDs and passwords are lease based and expire automatically after a period of time unless renewed. The device becomes disabled after the lease expires if it is misplaced or stolen. The software design also incorporates a capability for the system to the remotely disabled and confidential information destroyed as soon as it is turned on or is brought within wireless range if it is reported missing.

It will be appreciated that the invention can be constructed in whole or in part from special purpose hardware or a general-purpose computer system, or any combination thereof, any portion of which may be controlled by a suitable software program. Any software may in whole or in part comprise part of or be stored on the system in a conventional manner, or it may in whole or in part be provided in to the system over a network or other mechanism for transferring information in a conventional manner.

### DESCRIPTION OF ALTERNATE EMBODIMENTS

In another preferred embodiment, the invention can be used in a medical environment for delivering and monitoring patient care. The software operates in a device that acts as the focal point for patient care in a hospital room, recovery room or operating theater environment, where multiple communications capable, intelligent devices are brought together to monitor the patient, deliver medication and provide life support based upon prescribed therapies of one or more attending medical professional and rules and procedures of fundamental medical practices.

Architectural and design elements of the software invention are similar in this embodiment and the software functions in generally similar ways, although with some implementation differences. The primary difference is that the recipient of services is the patient, whose identity is used as an anchor or subject to which services are ‘locked-in’ or bound. Identity information (252 in FIG. 2) can be held in a separate device, such as an embedded wireless Bluetooth device on a patient's wristband. Needs, priorities, preferences, interests, delegation of responsibility and rules of behavior are specified for the patient by one or more authorized medical care giver, such as doctors, nurses, medical technicians for specific functions by means of user interface 112d, which can be accessible via multiple computing platforms from multiple locations to different authorized care givers.

In this embodiment, more of the service providers encountered have either proprietary (136 in FIG. 1) or general purpose (130, 132) wired connectivity or wireless local area (122) and personal area networking connectivity, such as via Bluetooth (124). Enterprise (hospital) systems (158) assume a key role and fewer services are offered remotely via the Internet (156). The service analyzer (242) and transaction manager (222) assume central roles in terms of coordinating services of multiple devices that may be unknown to each other for the specific needs of the current patent under care. Remote processing capabilities (160) are significant in cooperative processing in conjunction with hospital patient care systems to receive prescribed therapies and treatments from multiple care givers and to deliver patient information to remote monitoring stations in the hospital over a local area network (142) and remotely from doctors' and specialists' offices and homes via secure connectivity over a wide area network (140).

Service provider devices will exchange standard definitions of their services, service properties, hierarchy and relationships in XML or the like. These are used by the software to coordinate services of multiple devices to deliver prescribed treatments. The service analyzer determines what devices/services are available and what are still required in order to successfully deliver prescribed treatments and can alert medical staff of remaining equipment or medical supplies required.

Service provider devices are dynamically brought together to create a community of collaborative devices that are individually configured but collectively provide medical care appropriate to a patient. This includes medical equipment and monitoring devices attached to, or in the proximity of a patient in a hospital room, brought together at different phases of the patient's therapy and reconfigured depending upon the needs of different patients whom they serve. Sometimes, the software facilitates communication of the state/measurements of multiple devices monitoring the same patient. The software may monitor vital signs from a number of other equipment—with logic to analyze multiple instruments and send appropriate alerts based upon thresholds set by medical staff or based upon a prescribed therapy regimen.

In this scenario, a Bluetooth device on a patient's wristband, identifying the patient, is read by monitoring equipment in radio frequency proximity and communicates vital signs and other measurements of the patient to a central monitoring station as well as to each other, if necessary, through the intermediary of the software. The software ensures that each device is ‘locked’ on to the patient's identifier and displays this for manual confirmation and verifies patient identification from a second source by independently correlating/corroborating the room id, name, social security number, etc. from a central hospital system.

When the same equipment is wheeled into another room at a later time, it will configure itself to report on a different patient—possibly reading certain critical information based on the patient's Bluetooth id and a central system containing patient/case information. A doctor visiting patients can have access to key monitoring data, medical history and prescribed therapies on his PDA as he approaches each patient via the software from both local devices and a central system.

While this invention has been described in connection with what are presently considered to be the most practical and preferred embodiments, it is to be understood that the invention is not limited to the disclosed embodiment, but, on the contrary, is intended to cover various modifications and equivalent arrangements included within the spirit and scope of the invention.

What is claimed is:

1. Method and apparatus for delegating interaction with, management of and access to services and resources available, offered, provided or controlled by electronic means to a mobile and/or stationary computing device with plurality of wireless and/or wired connectivity and communications capability, whereby the computing device intermediates between a plurality of devices and/or software applications providing said services and resources and the recipient of said services or user of said resources.

2. The computing system of claim 1, further containing needs, priorities, preferences and interests of at least one individual and possessing a capability to receive and respond to requests for this information from service providers.

3. The computing system of claim 1, further providing a means for specifying a plurality of levels of delegated responsibility for different service provider devices or software applications.

4. The computing system of claim 1, further containing rules of behavior for said computing device to interact with a plurality of classes of service providers and services.

5. The computing system of claim 1, further defining boundaries within which freedom to make decisions and take actions is permitted and beyond which said freedom is limited for said computing device.

6. The computing system of claim 1, further providing a means for establishing a community of the independent devices and service providers.

7. The computing system of claim 1, further providing a means of coordinating services of a plurality of said service provider devices or software applications to produce a composite service of added value.

8. The computing system of claim 1, further providing a capability for devices to register a request to use services of other devices and service providers.

9. The computing system of claim 1, further providing a means for establishing an anchor, subject or recipient of services from devices and service providers.

10. The computing system of claim 1, further providing a simplified method for establishing generic behaviors, choices or preferences from examples of prior transactions.

11. The computing system of claim 1, further providing a capability to interpret said needs, priorities, preferences and interests and intermediating between a plurality of service provider devices and applications and the recipient of services in accordance with said delegated responsibilities and rules of behavior.

12. The computing system of claim 1, further possessing a capability to construct an anticipated series of desired services to be fulfilled when appropriate service providers become available.

13. The computing system of claim 1, further possessing a capability to construct an anticipated series of desired services to be fulfilled when appropriate service providers become available.

14. The computing system of claim 1, further providing a capability to act as a representative or surrogate of the service recipient in order to minimize human intervention and human action in interaction with devices and service providers without compromising beneficial opportunities.

15. The computing system of claim 1, further providing a method for distributing its operational capabilities to at least one other computing device in order to avoid limitations of storage, memory or computing capacity of one computing device and operating cooperatively with distributed computing elements among a plurality of computing devices as well as locally executing downloaded computing elements.

16. The computing system of claim 1, further providing a method for distributing storage of secure or confidential information among a plurality of secure repositories and transparently accessing said repositories to use said information in a secure manner.

17. The computing system of claim 16, further providing a method of issuing an encrypted digital key for one time use by a service provider to access a secure resource authorized by the said device in connection with a transaction with said service provider.

18. The computing system of claim 1, further providing a method for monitoring and delivering patient care, medication and life support in a medical environment based upon prescribed therapies of one or more attending medical professional, and rules and procedures of fundamental medical practices.

19. The computing system of claim 1, further providing software applications for remote control via the user interface of the computing device to operate devices and equipment such as domestic appliances, home entertainment, security and the like that are encountered, come within radio frequency proximity and establish ephemeral communications using personal area networking technologies such as Bluetooth as the computing device transitions through different environments.
